(19) United States
(12) Patent Application Publication
(10) Pub. No.: US 2009/0042684 A1
(43) Pub. Date: Feb. 12, 2009

(54) Flat Belt and Method for Production Thereof

(76) Inventors: Osamu Takahashi, Kobe (JP); Hideaki Kawahara, Kobe (JP)

Correspondence Address: WENDEROTH, LIND & PONACK, L.L.P., 2033 K STREET N. W., SUITE 800, WASHINGTON, DC, 20006-1021, US

(21) Appl. No.: 11/883,547

(22) PCT Filed: Jan. 16, 2006
(86) PCT No.: PCT/JP2006/300426

§ 371 Date: Aug. 2, 2007

(30) Foreign Application Priority Data
Feb. 2, 2005 (JP) 2005-026116

(51) Int. Cl. F16G 1/08

(52) U.S. Cl. 474/263; 156/137

(57) ABSTRACT

[Problems to be Solved]

By lowering the degree of close contact between a flat belt and the pulley surface of a pulley, it is possible to avoid production of separation noises, which sound “ji ji”. By increasing the coefficient of friction of the flat belt, it is possible to realize low-load transmission.

[Means for Solution]

The flat belt (1) consists of an upper rubber layer (2), a core layer (3), and an under rubber layer (4) which are laminated in order. The core layer (3) consists of adhesive rubber (3a) and a core cord (3b) which is wound spirally in the rubber. The upper belt surface (2a) and the under belt surface (4a) as belt transmission surfaces are rough rubber surfaces with fine irregularities. The rough rubber surfaces are formed by means of a vulcanization mold (11) or a vulcanization molding rubber sleeve (18) which has a shotblasted molding surface (sleeve surface), without post-working after the vulcanization molding.

### FIELD OF THE INVENTION

The present invention relates to a flat belt and a method for producing a flat belt.

### BACKGROUND OF THE INVENTION

A flat belt is one of the drive belts in wide use as general-purpose industrial belts. Because flat belts are used in a wide variety of fields, it may be required that their performance should include quietness in addition to transmission ability or capacity.

If the belt transmission surfaces of a flat belt have a high coefficient of friction, the belt is capable of transmission under low tension. This increases efficiency and lengthens the belt life. Therefore, it is required that the belt transmission surfaces of flat belts should have higher coefficients of friction.

Conventionally, if short fibers are mixed with the base rubber of a flat belt, the belt transmission surfaces of the belt are ground so that some of the fibers can be exposed from the rubber surfaces of the belt, as a measure against noises which may be made if the belt is used under relatively high load in slippery conditions.

In general, such a flat belt is produced by plying up belt materials on a mold so as to form an unvulcanized molded belt, and by pressurizing and heating the belt, with a rubber sleeve applied to its outer side, so as to vulcanization-mold it into a molded belt (refer to Patent Document 1, for example).

Specifically, as shown in FIG. 4, a required number of unvulcanized rubber sheets 12, which will be the under rubber layer of a flat belt, are wound on a surface of a cylindrical mold 11′, and subsequently an unvulcanized rubber sheet 13, which will be part of the adhesive rubber of the core layer of the belt, is wound around the sheets 12. Subsequently, a core cord 14 is wound spirally at a constant pitch in the width direction around the rubber sheet 13. Subsequently, unvulcanized rubber sheets 15 and 16, which will be part of the adhesive rubber and the upper rubber layer of the flat belt respectively, are wound in order around the core cord 14, so that an unvulcanized molded belt is produced.

Subsequently, as well known, with a vulcanization molding rubber sleeve applied to the outer side of the unvulcanized molded belt, this belt is heated and pressurized under constant conditions to be vulcanization-molded, so that a molded belt is obtained.

Subsequently, as shown in FIG. 5(a), with the vulcanized molded belt 21 wound about a spindle roller 22 large in diameter and a driven roller 23 small in diameter, a grinding (grindstone) roller 24 is applied at the spindle roller 22 to grind the belt surface. Subsequently, the molded belt 21 is cut into flat belts 26 of a predetermined width. Short fibers 25 are exposed from the rubber surfaces of the flat belts 26, so that the belt transmission surfaces 26a of the belts have a low coefficient of friction.
Patent Document 1: JP-H05-50443A (paragraphs 0022 and 0023 and FIG. 1)

### DISCLOSURE OF THE INVENTION

Problems which the Invention Tends to Solve

In general, a power transmission device with a flat belt is capable of transmission, with a flat surface of the belt in completely close contact with flat surfaces of pulleys. Therefore, if the contact for transmission is very close, the flat belt makes separation noises, which sound “ji ji” when it leaves the pulleys.

As stated already, the conventional fiat belt is produced by plying up materials on a vulcanization mold and vulcanization-molding them. If the conventional flat belt is made of rubber materials with which short fibers are mixed, its belt transmission surfaces are ground after vulcanization molding so that some of the fibers can be exposed. This lowers the coefficient of friction of the belt transmission surfaces, as a measure against noises which may be made if the belt is used with relatively high load and slips on pulleys. By the way, if efficiency is particularly required under relatively low load, it is necessary to lower the belt tension. In this case, it is required that the belt transmission surfaces of a flat belt should have a high coefficient of friction, because the conventional flat belt, the belt transmission surfaces of which have a low coefficient of friction, is poor in transmission ability.

The inventors have conceived that, in order to solve these problems, it is possible for a belt transmission surface of a flat belt to have properties suitable for the use of the belt by so preforming a portion of the molding surface of a vulcanization mold or a vulcanization molding rubber sleeve for belt vulcanization molding, the portion corresponding to the belt transmission surface, that the portion has properties corresponding to those required for the belt transmission surface, and by vulcanization-molding the belt transmission surface by means of the mold or the sleeve. The inventors have then come to make the present invention, which makes it easy to lower the degree of close contact between a belt transmission surface of a flat belt and the pulley surfaces of pulleys, thereby avoiding production of separation noises, which sound “ji ji”, and to raise the coefficient of friction of this surface, thereby enabling transmission under low load, by making the belt transmission surface have desired properties.

The object of the present invention is to lower the degree of close contact between a flat belt and the pulley surfaces of pulleys, thereby avoiding production of separation noises, which sound “ji ji”, and to raise the coefficient of friction of the belt, thereby enabling transmission under low load.

### Means for Solving the Problems

The invention of claim 1 is a method for producing a flat belt for transmitting motive power by being wound about a pulley, with a belt transmission surface of the belt in contact with the pulley surface of the pulley, the method being characterized in that a portion of the molding surface of a vulcanization mold or a vulcanization molding rubber sleeve for use in vulcanization-molding the belt, the portion corresponding to the belt transmission surface, is so preformed as to have a property corresponding to a property required for the belt transmission surface. In other words, this invention takes advantage of transferring a property of the molding surface of the vulcanization mold or vulcanization molding rubber sleeve to the belt transmission surface by so preforming the portion of the molding surface of the mold or sleeve which corresponds to the belt transmission surface that the portion has the property corresponding to the property required for the belt transmission surface, and by molding the belt by means of the mold or the sleeve.

This makes it possible to keep the belt transmission surface the rough rubber surface to which the property of the molding surface of the vulcanization mold or vulcanization molding rubber sleeve has been transferred. As a result, by adjusting the size and quantity of the fine irregularities of the belt transmission surface, it is possible to lower the degree of close contact between this surface and the pulley surface and raise the coefficient of friction of the belt transmission surface.

As described in claim 2, the molding surface of the vulcanization mold or vulcanization molding rubber sleeve may be shotblasted to have fine irregularities.

In this case, the property of the molding surface of the vulcanization mold or vulcanization molding rubber sleeve is transferred to the rough rubber surface as the belt transmission surface, so that the rubber surface has fine irregularities based on the shotblasting. This makes it possible to easily produce a flat belt that avoids making separation noises, which sound “ji ji” by lowering the degree of close contact between the belt transmission surface and the pulley surface.

As described in claim 3, short fibers may be arrayed in the belt width direction in the rubber part forming the belt transmission surface of the flat belt.

In this case, even if the rubber part forming the belt transmission surface is formed of rubber material with which short fibers are mixed, a surface of the material which will be the belt transmission surface is not so post-worked (ground or cut) as to be a belt transmission surface with short fibers exposed, but the surface which has not been ground is the belt transmission surface. This raises the coefficient of friction of the belt transmission surface, thereby making it easy to produce a flat belt which enables transmission under low load. In other words, the belt transmission surface increases the area occupied by the rubber part, so that the coefficient of friction between the belt and the pulley rises.

The invention of claim 4 is a flat belt produced by the method described in claim 2, the belt being characterized in that it has a belt transmission surface being a rough rubber surface with fine irregularities which corresponds to the shotblasted molding surface.

The property of the molding surface of the vulcanization mold or vulcanization molding rubber sleeve is transferred to the belt transmission surface of this belt, so that the transmission surface is a rough rubber surface having fine irregularities based on the shotblasting. This makes it possible to lower the degree of close contact between the belt transmission surface and the pulley surface of a pulley, thereby avoiding production of separation noises, which sound “ji ji”.

The invention of claim 5 is a flat belt produced by the method described in claim 3, the belt being characterized in that it has a belt transmission surface being a rough rubber surface still having a property which it has acquired after vulcanization (without being ground, cut, or otherwise post-worked).

Even if the rubber part forming the belt transmission surface of this belt is formed of rubber material with which short fibers are mixed, a surface of the material which will be the transmission surface is not so post-worked (ground or cut) as to be a belt transmission surface with short fibers exposed, but the surface which has not been ground is the belt transmission surface. This raises the coefficient of friction of the belt transmission surface, thereby enabling transmission under low load.

### ADVANTAGES OF THE INVENTION

Thus, the present invention enables a belt transmission surface (of a flat belt) to be a rough rubber surface to which a property of the molding surface of a vulcanization mold or a vulcanization molding rubber sleeve for vulcanization molding has been transferred. Accordingly, by adjusting the size and quantity of fine irregularities of the belt transmission surface, it is possible to lower the degree of close contact between this surface and the pulley surfaces of pulleys, thereby avoiding production of separation noises, which sound “ji ji”, and to raise the coefficient of friction of this surface, thereby enabling transmission under low load.

### Best Mode of Carrying Out the Invention

An embodiment of the present invention will be described below with reference to the drawings.

FIG. 1 is a sectional view of a flat belt according to the embodiment. FIGS. 2 and 3 are explanatory drawings showing a method for producing the flat belt.

As shown in FIG. 1, the flat belt 1 consists of an upper rubber layer 2, a core layer 3, and an under rubber layer 4 which are laminated in order. The core layer 3 consists of adhesive rubber 3a and a core cord 3b which is wound spirally in the rubber.

The upper belt surface 2a and the under belt surface 4a as belt transmission surfaces have fine irregularities.

In general, such a flat belt is produced by plying up belt materials on a mold and pressurizing and heating the plied materials so as to vulcanization-mold them into a molded belt. Specifically, as shown in FIGS. 2 and 3, a required number of unvulcanized rubber sheets 12, which will be the under rubber layer 4, are wound on a surface of a cylindrical mold 11, and subsequently an unvulcanized rubber sheet 13, which will be the adhesive rubber 3a of the core layer 3, is wound around the sheets 12. The surface 11a of the mold 11 is a rough rubber surface having fine irregularities formed by a method which will be described later on.

Subsequently, a core cord 14 is wound spirally at a constant pitch around the rubber sheet 13. Subsequently, other unvulcanized rubber sheets 15 and 16, which will be the adhesive rubber 3a and the upper rubber layer 2 respectively, are wound in order around the core cord 14, so that an unvulcanized molded belt 17 is produced.

Subsequently, with a vulcanization molding rubber sleeve 18 applied to the outer side of the unvulcanized molded belt 17, this belt is heated and pressurized under constant conditions to be vulcanization-molded, so that a molded belt is obtained. The sleeve surface 18a of the rubber sleeve 18, also, is a rough rubber surface having fine irregularities formed by the method which will be described later on.

During the vulcanization molding, properties of the surface 11a of the mold 11 are transferred to one of the surfaces (inner peripheral surface) of the molded belt, while properties of the sleeve surface 18a as a molding surface of the rubber sleeve 18 are transferred to the other surface (outer peripheral surface) of the belt.

The vulcanized molded belt is cut into flat belts 1 of a predetermined width. The vulcanization is not followed by post-working (refer to FIG. 5) for grinding the belt surface by winding the molded belt about a spindle roller large in diameter and a driven roller small in diameter and applying a grinding (grindstone) roller at the spindle roller.

Thus, the surface 11 a of the mold 11 and the sleeve surface 18a of the rubber sleeve 18 are transferred to the under surface 4a and the upper surface 2a respectively of the flat belt 1, so that the surfaces 2a and 4a as belt transmission surfaces of the flat belt 1 can be rough rubber surfaces having fine irregularities.

In order for the surface 11a of the mold 11 and the sleeve surface 18a of the rubber sleeve 18 to be rough rubber surfaces having fine irregularities, the surface 11a as a molding surface of the mold 11 may be shotblasted so that a molding surface having fine irregularities (surface roughness: at least 6.3 s) can be formed, and the mold for producing the rubber sleeve 18 may be shotblasted so that a rubber sleeve having a shotblasted surface as a molding surface can be produced. The use of such a mold 11 and such a rubber sleeve 18 makes it easy to transfer the shotblasted surfaces to the surfaces (belt transmission surfaces) of the molded belt.

The present invention can be embodied otherwise as follows.
(i) Both of the upper belt surface 2a and under belt surface 4a might not be limited to surfaces (shotblasted surfaces) with fine irregularities. If only one of the belt surfaces 2a and 4a were a belt transmission surface, it would be essential that this surface be a surface (shotblasted surface) with fine irregularities.
(ii) The upper and under rubber layers of a flat belt may be made of rubber with which short fibers are mixed. In this case, after vulcanization molding, the molded belt is used as it is without its surfaces ground, cut, or otherwise post-worked. As a result, the belt transmission surfaces have fine irregularities formed by transferring the properties of the molding surface of the vulcanization mold or vulcanization molding rubber sleeve as it is to the transmission surfaces, and the short fibers are not exposed. This makes it possible for the belt transmission surfaces to have a high coefficient of friction. In this case, the rate at which short fibers are exposed is 1 or less % of the total surface area of the belt transmission surfaces.

This enables efficient belt transmission with relatively low load even under low belt tension because the belt transmission surfaces are rough rubber surfaces with a high coefficient of friction.

### BRIEF DESCRIPTION OF THE DRAWINGS

FIG. 1 is a sectional view of a flat belt according to an embodiment of the present invention.

FIG. 2 is an explanatory drawing showing a method for producing the flat belt.

FIG. 3 is an explanatory drawing showing the method for producing the flat belt.

FIG. 4 is an explanatory drawing showing a method for producing a conventional flat belt.

FIG. 5(a) is an explanatory drawing showing a process for producing (the step of grinding) the conventional flat belt. FIG. 5(b) is an explanatory drawing of the ground molded belt.

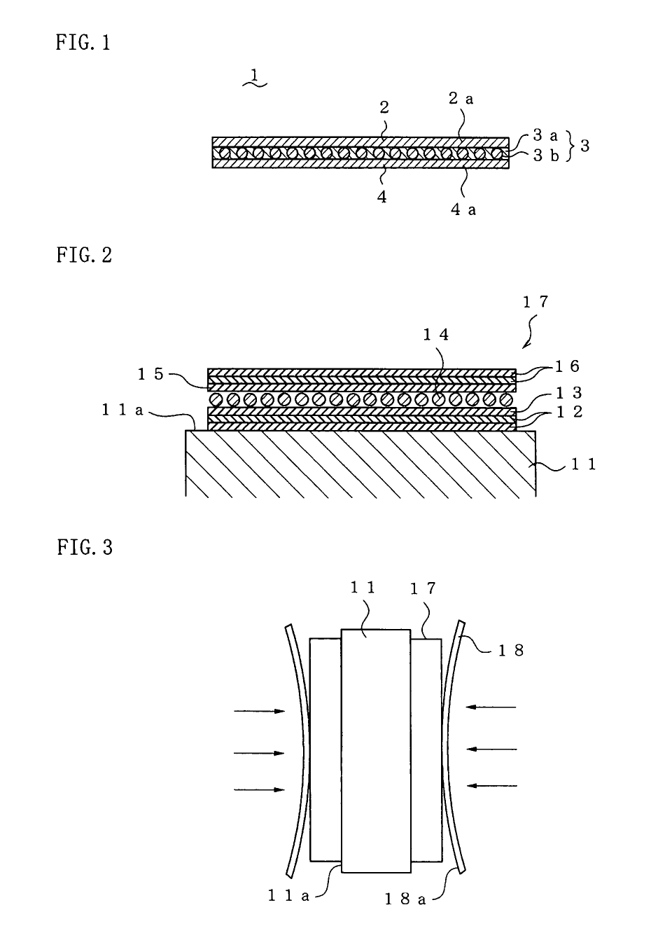

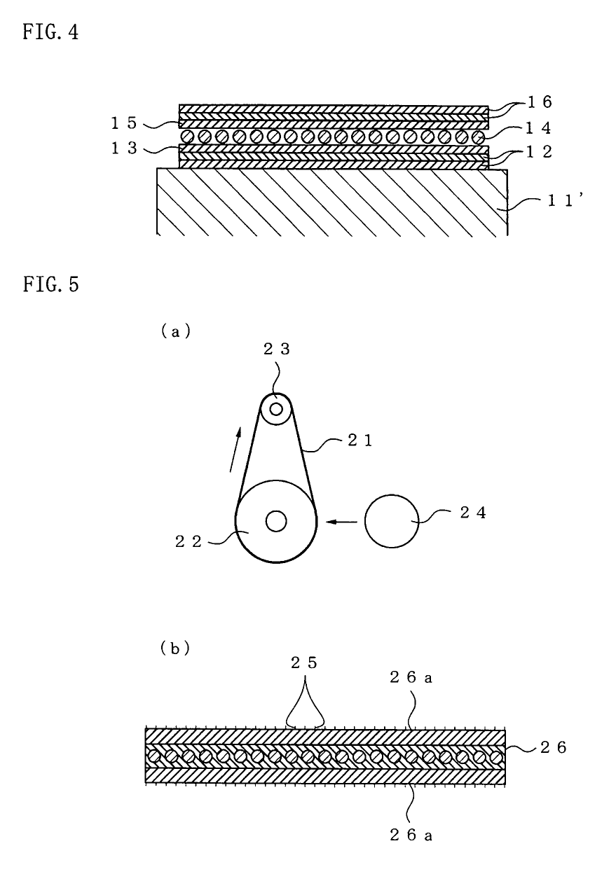

### WHAT IS REPRESENTED BY REFERENCE NUMERALS

1: flat belt

2a: upper belt surface

4a: under belt surface

11: vulcanization mold

11a: surface (molding surface)

18: vulcanization molding rubber sleeve

18a: sleeve surface

1. A method for producing a flat belt for transmitting motive power by being wound about a pulley, with a belt transmission surface of the belt in contact with the pulley surface of the pulley, the method being characterized in that a portion of the molding surface of a vulcanization mold or a vulcanization molding rubber sleeve for use in vulcanization-molding the belt, the portion corresponding to the belt transmission surface, is so preformed as to have a property corresponding to a property required for the belt transmission surface.

2. The method described in claim 1 and further characterized in that the molding surface of the vulcanization mold or vulcanization molding rubber sleeve is shotblasted to have fine irregularities.

3. The method described in claim 1 and further characterized in that short fibers are arrayed in the belt width direction in the rubber part forming the belt transmission surface of the flat belt.

4. A flat belt produced by the method described in claim 2, the belt being characterized in that the belt has a belt transmission surface being a rough rubber surface with fine irregularities, the rough rubber surface corresponding to the shotblasted molding surface.

5. The flat belt produced by the method described in claim 3, the belt being further characterized in that the belt transmission surface is a rough rubber surface still having a property which the belt transmission surface has acquired after vulcanization.
